(19) United States
(12) Patent Application Publication
(10) Pub. No.: US 2008/0247204 A1
(43) Pub. Date: Oct. 9, 2008

(54) Regulator Device for a Three-Phase Ac Machine

(75) Inventor: Folker Renken, Wilhelmshaven (DE)

Correspondence Address: LERNER GREENBERG STEMER LLP, P O BOX 2480, HOLLYWOOD, FL, 33022-2480, US

(73) Assignee: VDO AUTOMOTIVE AG, Munich (DE)

(21) Appl. No.: 12/065,540

(22) PCT Filed: Aug. 28, 2006
(86) PCT No.: PCT/EP2006/065718

§ 371 Date: Mar. 3, 2008

(30) Foreign Application Priority Data
Sep. 2, 2005 (DE) 10 2005 041 825.2

(51) Int. Cl. H02M 7/48

(52) U.S. Cl. 363/124

(57) ABSTRACT

A regulating apparatus for a three-phase AC machine has a DC controller and an inverter. An input of the inverter is coupled to the DC controller and an output of the inverter can be coupled to the AC machine.

The invention relates to a regulator device for a three-phase AC machine. Three-phase AC machines are used in particular for feeding a vehicle electrical system in the generator mode of operation of a motorized vehicle and/or in the engine mode of operation. In this regard the hybrid drive, as it is known, is becoming increasingly important. In this case the vehicle has not only an internal combustion engine but also the three-phase AC machine for driving the vehicle. Components that are disposed in a motorized vehicle must be able to withstand very high variations in temperature and provide long-term operation.

The object of the invention is to create a regulator device for a three-phase AC machine, which regulator device is both simple and inexpensive.

The object is achieved by the features of the independent claim. Advantageous embodiments of the invention are characterized in the dependent claims.

The invention is characterized by a regulator device for a three-phase AC machine having a DC chopper converter and an inverter which is coupled on the input side to the DC chopper converter and can be coupled on the output side to the three-phase AC machine. DC chopper converters are also referred to as DC/DC converters and have the ability to convert direct current of a given voltage into direct current of a different voltage. By means of the DC chopper converter a magnitude of a voltage or current can easily be set on the input side of the inverter and the inverter can then be driven exclusively in the square wave mode of operation. The inverter can thus serve simply as a polarity inverter. In this way the controllability of the three-phase AC machine is ensured on the one hand, and on the other hand the cost for one or more capacitors of the regulator device is relatively low and in particular the use of expensive electrolytic capacitors can be avoided. This is desirable since capacitors of that type require a considerable amount of space and furthermore there is a significant risk when electrolytic capacitors are used, since the electrolytes are usually flammable.

According to an advantageous embodiment of the invention, the DC chopper converter is coupled to the inverter via a voltage intermediate circuit and the inverter is a voltage-fed inverter, which can also be referred to as an inverter with input-side voltage injection. This is easy to implement.

According to another advantageous embodiment of the regulator device, the DC chopper converter is coupled to the inverter via a current intermediate circuit and the inverter is a current-fed inverter, which can also be referred to as an inverter with input-side current injection. In this way the capacitor expenditure can be kept particularly low.

According to a further advantageous embodiment of the regulator device, the DC chopper converter is embodied as a step-down (buck) converter. This is particularly easy to implement.

According to a further advantageous embodiment of the regulator device, the DC chopper converter is embodied as a multi-phase step-down (buck) converter. This has the advantage that in this way the input-side voltage or, as the case may be, the input-side current with which the inverter is fed, can be set very dynamically, in particularly quickly, and therefore a very high quality of control can be achieved. Furthermore, the currents can be distributed to individual branches of the step-down (buck) converter. In addition, a current load for a capacitor which may be arranged on the input side of the inverter is thus reduced as the number of branches of the step-down (buck) converter increases.

Exemplary embodiments of the invention are explained in more detail below with reference to the schematic drawings, in which:

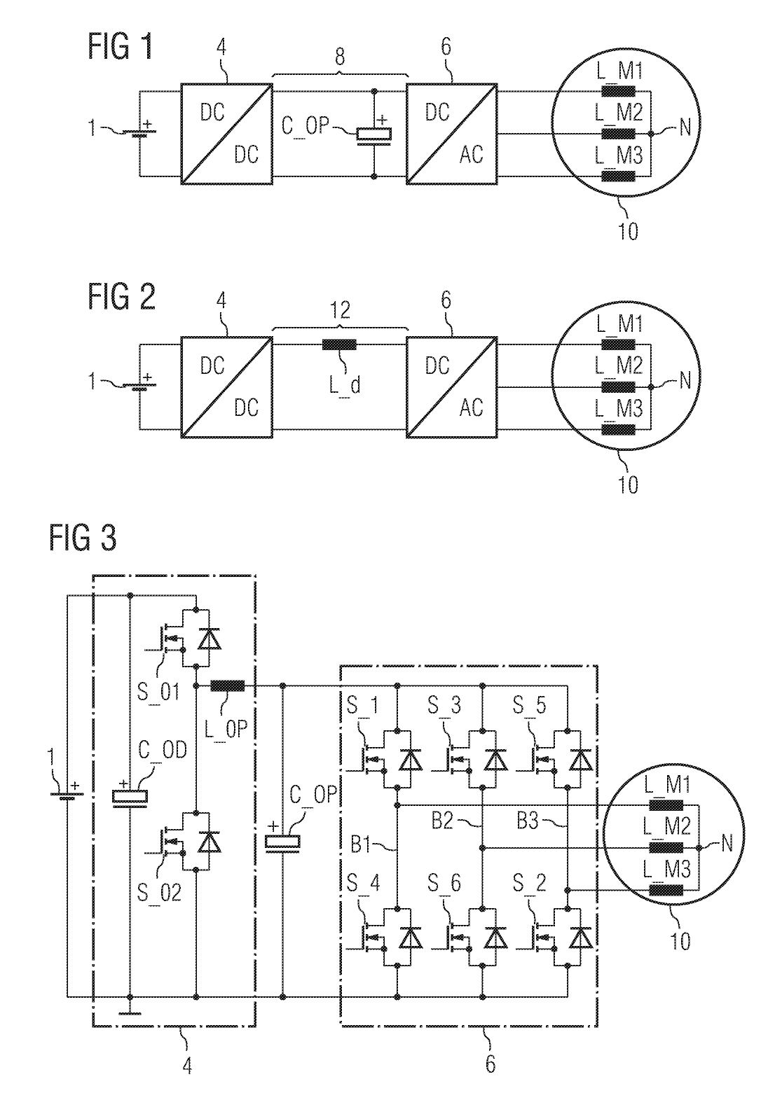

FIG. 1 shows a regulator device for a three-phase AC machine,

FIG. 2 shows a further regulator device for the three-phase AC machine,

FIG. 3 shows a more detailed schematic of the regulator device according to FIG. 2,

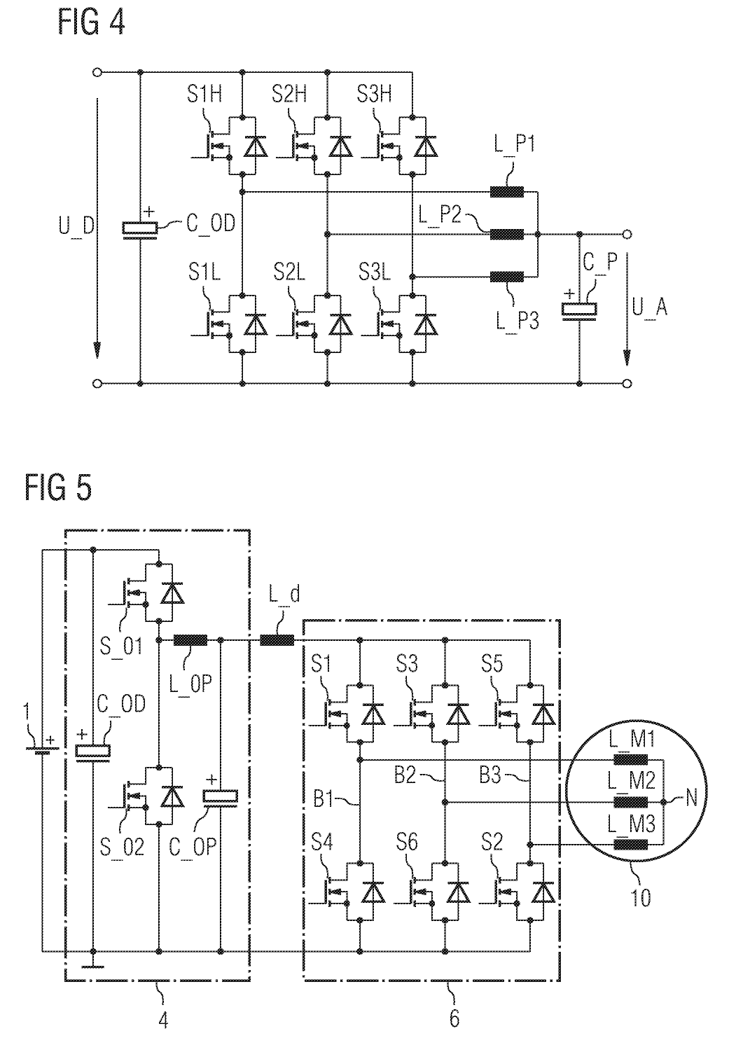

FIG. 4 shows a DC chopper converter,

FIG. 5 shows a more detailed schematic of the further regulator device according to FIG. 3, and

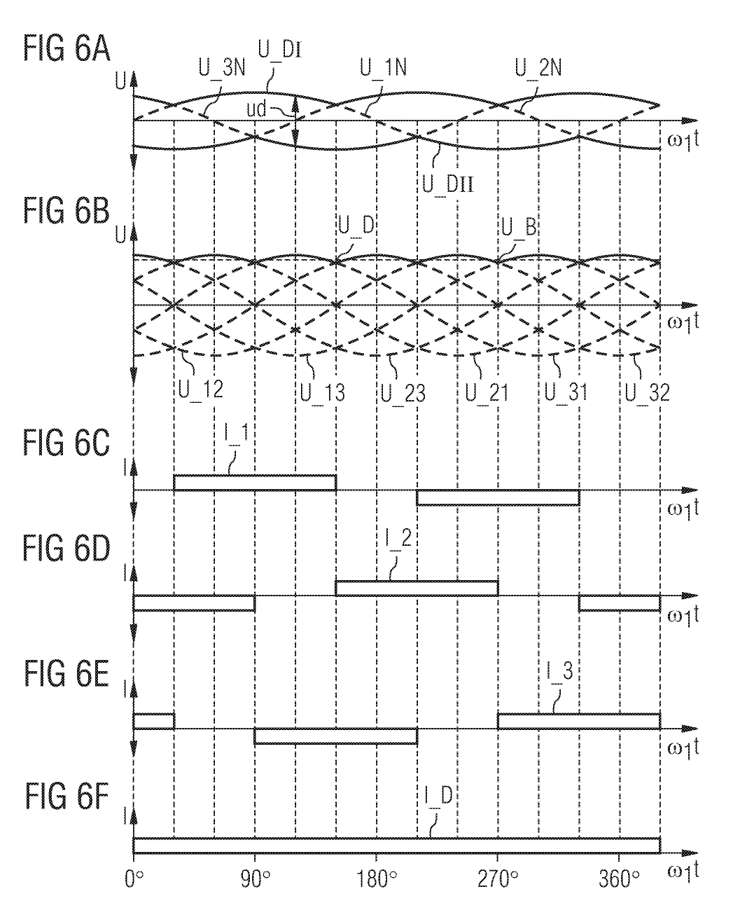

FIGS. 6a to f show voltage and current waveforms for the further regulator device according to FIG. 5.

A regulator device is assigned to a three-phase AC machine 10 (FIG. 1). The three-phase AC machine can be, for example, an asynchronous machine or a synchronous machine. It is supplied from, for example, a DC voltage source 1 which may be, for example, a vehicle electrical system and/or a battery of a motorized vehicle (engine operation). However, it may also feed the DC voltage source 1 in the generator mode of operation. The three-phase AC machine is preferably used in a motorized vehicle, but can also be used for any other type of application. The regulator device comprises a DC chopper converter 4 which is coupled to an inverter 6 via an intermediate circuit. In the embodiment according to FIG. 1, the intermediate circuit is a voltage intermediate circuit 8 having a capacitor C_0P. The DC chopper converter 4 is coupled to the DC voltage source 1. The inductors of the three-phase AC machines are labeled L_M1, L_M2 and L_M3.

A possible more concrete embodiment of the regulator device according to FIG. 1 is illustrated with reference to FIG. 3. The DC chopper converter 4 is embodied as a step-down (buck) converter and for that purpose comprises a capacitor C_0D electrically connected in parallel with the voltage source and switch S_01 and switch S_02 connected parallel thereto and arranged in series. The switches in each case comprise diodes embodied in parallel. Arranged at a tapping point which is located electrically between the switches S_01 and S_02 is an inductor L_0P which, together with the capacitor C_0P, forms an output filter. By driving the switches S_01 and S_02 in a suitable manner it is possible to set a suitable input voltage for the inverter via the capacitor C_0P, which input voltage can therefore be varied as a function of the driving of the switches S_01 and S_02.

The capacitor C_0P thus forms part of the output filter of the DC chopper converter on the one hand and on the other hand also the capacitor of the voltage intermediate circuit 8. The inverter 6 comprises first to third bridge branches B1 to B3 having switches S1, S3, S5 and S4, S6, S2 arranged on a high side and a low side, respectively. The three-phase AC machine is supplied with AC voltage via the bridge branches B1 to B3. The upper switches S1, S3, S5 or, as the case may be, the lower switches S4, S6, S2 are always triggered for the length of half a fundamental frequency period and consequently are driven in a 180-degree square wave mode of operation. The sum of the bridge currents, which are referred to as phase currents, on the DC voltage side yields a current with a small alternating component. The result is that the capacitor C_0P in the DC voltage input is subject to substantially less load compared with a pulse-controlled inverter. Furthermore, the current can be compensated in the input by means of the DC chopper converter.

The switches S1, S3, S5, S4, S6, S2 of the individual bridge branches B1 to B3 are in each case triggered offset by 120 degrees.

The DC chopper converter 4 embodied as a step-down (buck) converter in FIG. 4 is shown merely by way of example. Basically, any DC chopper converter, also termed DC/DC converter, that is capable of operating bi-directionally can be used. Any DC/DC converter which can increase and reduce, or reduce and increase, a voltage can be used.

A particularly preferred embodiment of the DC chopper converter 4 is explained in more detail with reference to FIG. 4. In this embodiment the DC chopper converter 4 is realized as a multi-phase DC chopper converter. It is embodied by way of example as a three-phase DC chopper converter 4 and comprises three bridge branches to each of which upper and lower switches S1H, S2H, S3H, S1L, S2L, S3L are assigned, where upper switches denote those switches which are arranged on what is referred to as the high-side, and the lower switches denote those switches which are arranged on the low side, which is to say the lower potential relative to the DC voltage potential. The multi-phase DC chopper converter 4 also comprises inductors L_P1, L_P2, L_P3 assigned to the respective bridge branches. The three-phase DC chopper converter 4 is also embodied as a step-down (buck) converter. The multi-phase capability of the DC chopper converter 4 means that an increase in control dynamics can be achieved; thus, in the case of the three-phase DC chopper converter 4, for example, possibly three times the control dynamics compared to the DC chopper converter according to FIG. 3, if in both cases the maximum switching frequencies of the switches S1H to S3H and S1L to S3L or S_01 and S_02 are used. In this way the cost for the necessary capacitance that is implemented by means of capacitors can be reduced and consequently the manufacturing costs can also be reduced still further.

A big advantage of the possible square wave mode of operation is that the three-phase AC machine is now also driven by means of fundamental frequency pulses. As a result the electrical radiation interference (EMC) of the system consisting of regulator device and three-phase AC machine 10 is significantly reduced, since no higher frequency pulsed useful signal leaves the regulator device.

In a further embodiment of the regulator device (see FIG. 2) the intermediate circuit is embodied as a current intermediate circuit 12. In this way it is possible to dispense entirely with a capacitor in the input of the inverter 6. Only the inductor L_d is disposed on the input side of the inverter 6. A more detailed schematic representation of this embodiment for a DC chopper converter 4 likewise embodied as a step-down (buck) converter by way of example is shown in FIG. 5. In contrast to FIG. 3, the capacitor C_0P can be embodied with a considerably lower capacitance and consequently said capacitor can be implemented much more compactly and therefore more cheaply. Here, too, the capacitor C_0P and the inductor L_0P form an output filter of the DC chopper converter 4.

The upper switches S1, S3, S5 are in each case triggered offset by 120 degrees and moreover for 120 degrees in each case. The lower switches S4, S6, S2 located in the respective same bridge branch are likewise triggered offset by 120 degrees relative to one another and moreover also for 120 degrees in each case, but offset by 180 degrees relative to the respective upper switches of the associated bridge branch. The result of this on the high side, for example, is that in each case one of the switches S1, S3, S5 conducts current for one third of the fundamental frequency period. The inductor L_d acts on the DC voltage side of the inverter as a choke for smoothing the current.

With reference thereto, FIG. 6.a shows by way of example the voltages U_1N, U_2N, U_3N at the bridge branches B1-B3 relative to the neutral point N, which can also be referred to as the star point. In this case U_dI denotes the voltage potential at the high-side input and U_dII the voltage potential at a low-side input of the inverter 6 relative to the neutral point N. The difference between the two voltages yields the voltage U_d at the input of the inverter 6.

FIG. 6b shows the respective voltages between the respective bridge branches B1 to B3 and specifically the indices in each case denote the respective voltage differences between the bridge branches B1 to B3. The voltage U_d is the voltage at the input of the inverter 6.

FIGS. 6c to e show the currents I_1 to I_3 in the first to third bridge branches B1 to B3. FIG. 6f shows the current I_d flowing at the input of the inverter 6. The form of representation is idealized for an infinitely large inductor L_d. In practice a smaller value is chosen for the inductor L_d, resulting in a certain ripple in the current.

1-5. (canceled)

6. A regulator device for a three-phase AC machine, comprising:
a DC chopper converter;
an inverter having an input side connected to said DC chopper converter and an output side connectable to the three-phase AC machine.

7. The regulator device according to claim 6, which comprises a voltage intermediate circuit connected between said DC chopper converter and said inverter, and wherein said inverter is an inverter having input-side voltage injection.

8. The regulator device according to claim 6, which comprises a current intermediate circuit connected between said DC chopper converter and said inverter, and wherein said inverter is an inverter having input-side current injection.

9. The regulator device according to claim 6, wherein said DC chopper converter is a step-down converter.

10. The regulator device according to claim 6, wherein said DC chopper converter is a multi-phase step-down converter.
